(19) United States
(12) Patent Application Publication
(10) Pub. No.: US 2007/0166203 A1
(43) Pub. Date: Jul. 19, 2007

(54) Self-sealing high-temperature biochemical reaction apparatus and method for the same

(75) Inventors: Chien-Chih Huang, Hsinchu (TW); Mei-Ya Wang, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/414,202

(22) Filed: May 1, 2006

(30) Foreign Application Priority Data
Jan. 13, 2006 (TW) 95101320

(51) Int. Cl. B01J 19/00

(52) U.S. Cl. 422/130

(57) ABSTRACT

The present invention provides a self-sealing high-temperature biochemical reaction apparatus and a method for the same. The present apparatus has a microfluidic channel including a main channel chamber, an inlet sub-channel and an outlet sub-channel. The main channel chamber has an inlet and an outlet respectively communicated with the inlet sub-channel and outlet sub-channel. The inner diameters of the inlet sub-channel and outlet sub-channel are smaller than that of the main channel chamber. The present invention controls the temperature gradient of the main channel chamber and sub-channels during the biochemical reaction such that the microfluid itself becomes self-sealing material to seal the openings of the sub-channels during the high-temperature reaction. The microfluid would not be vaporized to adversely influence the reaction result.

### BACKGROUND OF THE INVENTION

1. Field of the Invention

The present invention relates to a high-temperature biochemical reaction apparatus and method for the same; and more particularly to a high-temperature biochemical reaction apparatus and method for the same using reaction fluid itself as a self-sealing material.

2. Description of the Related Art

Biochemical reaction usually is carried out at a temperature higher than room temperature for a long time. And when the reaction reagent fluid volatilizes, vaporizes or boils, the composition of the reaction reagent will be varied dramatically so as to influence the result of the biochemical reaction. Polymerase chain reaction (PCR) is a thermal cycle type DNA duplicate method proposed by Kary Mullis in 1985, which carries out chain duplication of specific DNA with DNA polymerase in vitro. PCR is a modern technology to enlarge a trace of gene to sufficient amounts for identification, which can apply to diagnosis and evaluation for hereditary disease, tumor and cancer, and also can apply to diagnosis for virus or bacillus infection. The principle of PCR is to make the reaction reagent passing through three different reaction temperature stages to duplicate a section of double-helix DNA to two sections of double-helix DNA. The three different reaction temperature stages constitute a cycle, and the same cycle repeats again and again (more than 30 times) to let original specific DNA fragment chain duplicate by amounts of exponent of 2. PCR reaction usually needs to operate under a temperature higher than room temperature for a long time, and the fluid amount of the microfluidic chip usually is several μL. Although the reaction can easily and rapidly reach the required temperature by heating, the less amount of the reaction fluid makes the vaporization of the reaction fluid become an important factor, and a little vaporization amount will easily lead to the change of the percentage of PCR reaction reagent composition, even dry up the reaction reagent fluid and make the reaction fail. During the biochemical reaction, especially when using a smaller amount of the reaction reagent, it is necessary to prevent the reaction. reagent from volatilization, vaporization or boiling to avoid the change of the percentage of the reaction reagent composition.

Mathies et al. at Berkeley University, in Sensors and Actuators B 63, 2000, P138-146, disclosed a special valve designed for a biochemical reaction chip, as shown in FIG. 6, the valve is positioned respectively at two outlets of the reaction chamber, and one opening of the reaction chamber is pressed by an O-ring pushed by pressurized gas. With pressurized gas pressing O-ring, inner pressure of the reaction chamber is larger than atmospheric pressure during the PCR reaction such that the fluid of the reaction chamber does not contact with atmosphere during the PCR reaction. Nevertheless the whole structure of this design is complicated, and it is not easy to operate and control the design.

D. S. Yoon et al. in J. Micromech. Microeng. 12, 2002, P813-823, disclosed a method for sealing an opening of a microfluidic chip by pressing with O-ring to prevent the fluid in the channel of the microfluidic chip from contacting with atmosphere. This method needs additional clipping devices disposed on the microfluidic chip to position joint elements such as screws, and hence making O-ring tightly contact with the microfluidic chip by the pressure produced by the joint elements so as to suppress the pressure produced from the biochemical reaction in the opening of the reaction chamber. For the design of the valve, it is not necessary to control the switch of the valve, but the disassembly process is too complicated. And the inner pressure of the reaction chamber is larger than atmospheric pressure during the biochemical reaction process. As such, it is difficult to take out the fluid from the reaction chamber.

U.S. Pat. No. 6,664,044 discloses a method for conducting PCR protected from evaporation, in which reaction reagent has an amount as large as a single liquid droplet injected from an inkjet printer. This patent provides a sealing method to coat a layer of oil on the outer surface of the liquid droplet of the reaction reagent. The vaporizing temperature of the oil is higher than that of the reaction reagent to prevent the reaction reagent from contacting with atmosphere. During the PCR reaction process, this sealing method makes the pressure of the reaction reagent is the same with atmospheric pressure. But due to the mixing of the oil and water, it is necessary to separate the oil and water by labor work to take out the reagent before the subsequent manipulation process.

Accordingly, it is desirable to develop a self-sealing high-temperature biochemical reaction apparatus and method for the same.

### SUMMARY OF THE INVENTION

One objective of the present invention is to provide a self-sealing high-temperature biochemical reaction apparatus and method for the same, which controls temperature gradients of a reaction area of a microfluidic channel and surrounding environment during a biochemical reaction, such that reaction fluid itself can seal the microfluidic channel to prevent the reaction fluid from being vaporized during a high-temperature biochemical reaction so as to facilitate the biochemical reaction.

It is another objective of the present invention to provide a self-sealing high-temperature biochemical reaction apparatus and method for the same, which utilizes the reaction fluid itself to seal the microfluidic channel without additional sealing components and is helpful to take out the resultant product as well as attaining cost down.

According to the above objectives, the present invention provides a self-sealing high-temperature biochemical reaction apparatus, which comprises a microfluidic channel having a main channel chamber, an inlet sub-channel and an outlet sub-channel, wherein the main channel chamber has an inlet and outlet respectively communicated with the inlet sub-channel and outlet sub-channel, and inner diameters of the inlet sub-channel and outlet sub-channel are smaller than that of the main channel chamber. The temperature of the main channel chamber is controlled higher than the temperature of the sub-channel during a biochemical reaction of a reaction reagent filled in the microfluidic channel such that the reaction reagent itself seals the inlet sub-channel and outlet sub-channel so as to prevent the reaction reagent from being vaporized in the main channel chamber to facilitate the biochemical reaction.

In one another aspect, the present invention provides a self-sealing high-temperature biochemical reaction method, which comprises: providing a microfluidic chip having a main channel chamber, an inlet sub-channel and an outlet sub-channel, wherein the main channel chamber has an inlet and outlet respectively communicated with the inlet sub-channel and outlet sub-channel, and inner diameters of the inlet sub-channel and outlet sub-channel are smaller than that of the main channel chamber; introducing reaction reagent fluid into the inlet sub-channel, the main channel chamber and the outlet sub-channel; detecting a temperature of the main channel chamber and accordingly generating a feedback signal; and outputting a control signal depending on the feedback signal to control the main channel chamber to reach a reaction temperature higher than the surrounding temperature such that the reaction reagent itself seals the inlet sub-channel and outlet sub-channel.

The present self-sealing high-temperature biochemical reaction apparatus has a simple structure, which utilizes reaction reagent itself as a sealing material without additional sealing components such that cost down can be obtained. Furthermore, the present high-temperature biochemical reaction apparatus and its sealing method are easy to implement and hence have commercial potential.

### BRIEF DESCRIPTION OF THE DRAWINGS

FIG. 1A shows a schematic top view of a self-sealing high-temperature biochemical reaction apparatus according to a first embodiment of the present invention.

FIG. 1B shows a schematic cross-sectional view of FIG. 1A.

FIG. 2A shows a schematic top view of a self-sealing high-temperature biochemical reaction apparatus according to a second embodiment of the present invention.

FIG. 2B shows a schematic cross-sectional view of FIG. 2A.

FIG. 3 depicts a temperature record of a reaction chamber in a microfluidic chip of the present invention during a PCR reaction.

FIG. 4 shows a surface temperature distribution of the microfluidic chip of the present invention during the PCR reaction.

FIG. 5 shows a PCR reaction result analysis of the apparatus of the present invention.

FIG. 6 shows a valve structure of a conventional chip.

### DETAILED DESCRIPTION OF THE PREFERRED EMBODIMENTS

The self-sealing high-temperature biochemical reaction apparatus of the present invention adopts a special microfluidic channel design and temperature gradient control to make some portion of reaction fluid as a self-sealing material to prevent the reaction fluid from being vaporized to adversely influence the reaction result. Besides, the present invention can simplify the sealing problem and avoid the complicated problems encountered for separating oil and water and the mechanical motion to plaster gummed tape, and improving operability of the microfluidic chip as well as making automation of the microfluidic chip become possible. More specifically, the present invention coordinates temperature gradient made by the heater with the size of the microfluidic channel to make most reaction reagent in the microfluidic channel placing in a primary reaction temperature area and less reaction reagent placing in a low-temperature non-vaporization area so as to serve as a sealing material.

The self-sealing high-temperature biochemical reaction apparatus and method for the same will be described in detail according to the following embodiments with reference to accompanying drawings.

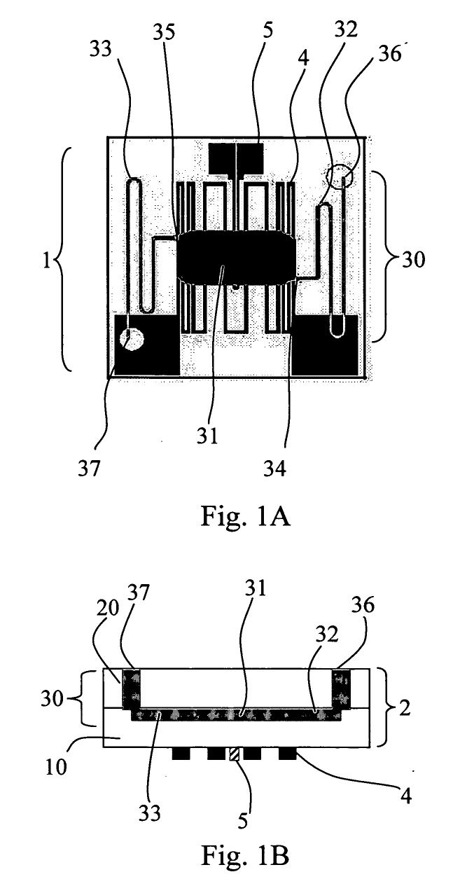

FIG. 1A shows a schematic top view of the self-sealing high-temperature biochemical reaction apparatus according to the first embodiment of the present invention, and FIG. 1 B shows a schematic cross-sectional view of FIG. 1A. Referring to FIG. 1A, in the first embodiment, the self-sealing high-temperature biochemical reaction apparatus 1 includes a microfluidic chip 2, a heater 4 and a temperature sensor 5. The microfluidic chip 2 has a first substrate 10 and a second substrate 20. The first substrate 10 has a designed microfluidic channel area 30 formed therein, and the microfluidic channel area 30 includes a main channel chamber 31, an inlet sub-channel 32 and an outlet sub-channel 33. The main channel chamber 31 is designed as a single chamber, and the inlet sub-channel 32 and the outlet sub-channel 33 are designed as bending channels, but also the inlet sub-channel 32 and the outlet sub-channel 33 can be designed as straight-line channels. The volume of the main channel chamber 31 is larger than that of the inlet sub-channel 32 and the outlet sub-channel 33. And the inner diameter of the main channel chamber 31 is larger than those of the inlet sub-channel 32 and the outlet sub-channel 33. Moreover, the volumes of the inlet sub-channel 32 and the outlet sub-channel 33 need to be larger than a volume increased by thermal expansion of the main channel chamber 31. The main channel chamber 31 has a main channel chamber inlet 34 and a main channel chamber outlet 35 respectively communicated with the inlet sub-channel 32 and outlet sub-channel 33. The second substrate 20 is positioned over the first substrate 10 to make the microfluidic channel area 30 become a closed fluid channel area. The second substrate 20 has a microfluidic channel inlet 36 and a microfluidic channel outlet 37 respectively communicated with the inlet sub-channel 32 and outlet sub-channel 33. The heater 4 is a heat-producing device, such as a resistance heater, an infrared ray heater, or one hot end of a refrigerator. The heater 4 is positioned under the first substrate 10 corresponding to the main channel chamber 31 to control the temperature of the main channel chamber 31. The temperature sensor 5 is associated with the heater 4 under the first substrate 10. The temperature sensor 5 can be a resistance temperature detector (RTD), thermocouple type, or infrared ray type, to detect the temperature of the main channel chamber 31 and feedback a signal to the present system to do feedback control so as to control the heater 4 to heat the main channel chamber 31 to reach the reaction temperature.

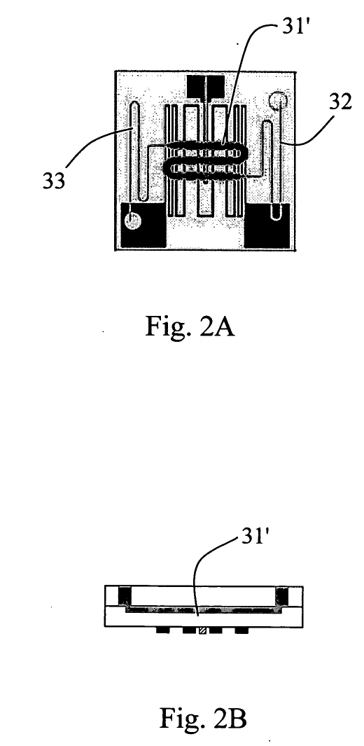

FIG. 2A shows a schematic top view of a self-sealing high-temperature biochemical reaction apparatus according to the second embodiment of the present invention, and FIG. 2B shows a schematic cross-sectional view of FIG. 2A. The difference between the second embodiment and the first embodiment is that the main channel chamber 31′ is designed as a multi-bending channel, and the inner diameter of the inlet sub-channel 32 and outlet sub-channel 33 are smaller than that of the multi-bending channel. Besides, the volume of the main channel chamber 31′ is larger than those of the inlet sub-channel 32 and outlet sub-channel 33. And the volumes of the inlet sub-channel 32 and outlet sub-channel 33 need to be larger than a volume increased by thermal expansion of the main channel chamber 31. In addition, the position relationship of the heater 4 and main channel chamber 31 can be determined relying on demands. The heater 4 can be positioned over or under the main channel chamber 31 to facilitate heating the main channel chamber 31.

Using the self-sealing high-temperature biochemical reaction apparatus of the present invention to conduct a PCR reaction, the reaction reagent fluid is introduced into the inlet sub-channel 32, main channel chamber 31 and the outlet sub-channel 33 through an inlet 36 of the inlet sub-channel 32. In the present invention, the material of the first substrate 10 and second substrate 20 of the microfluidic chip 2 can be glass, silicon-based material, silica gel or polymer, which is inactive with the reaction reagent.

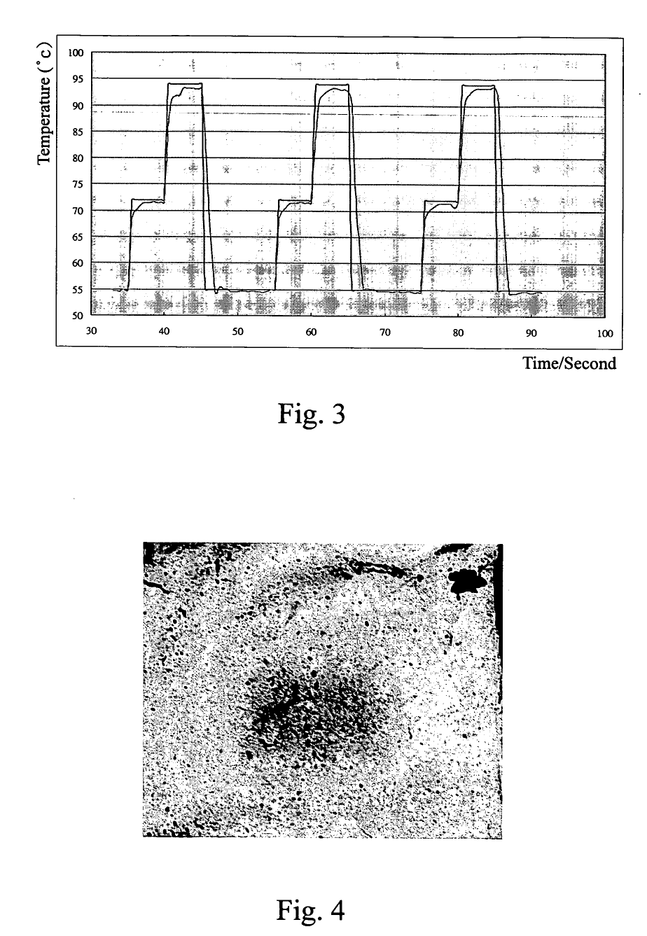

At the beginning of the PCR reaction, the temperature sensor 5 is used to sense the temperature of the main channel chamber 31 and feedback a signal to the present system (a computer or a control chip) for computation. The present invention utilizes a PID (Proportional-lntegral-Differential) logic control to generate a feedback signal in accordance with the temperature of the main channel chamber 31 detected by the temperature sensor 5, and sending the feedback signal to the heater 4 so as to control the main channel chamber 31 to reach the reaction temperature by the heater 4, while the ambient temperature surrounding the main channel chamber 31 is still near to room temperature. In other words, when the PID controller feedbacks a control signal to the heater 4, the heater 4 can provide thermal energy to the main channel chamber 31 such that the main channel chamber 31 can reach the required reaction temperature. Contrariwise, when the temperature of the main channel chamber 31 is higher than the required reaction temperature, the PID controller also feedbacks a control signal to the heater 4 to stop heating. Besides, the present apparatus carrying out the biochemical reaction requires a kind of temperature gradient distribution, in which just only the main channel chamber 31 reaches the required high temperature for carrying out the PCR reaction, but the inlet sub-channel 31 and outlet sub-channel 32 have a lower temperature near to the room temperature. FIG. 4 shows a surface temperature distribution of the microfluidic chip 2, which also reveals that the present invention can reach a highly precise temperature control. Furthermore, FIG. 3 shows a temperature record of the main channel chamber 31 when using the microfluidic chip 2 of the present invention to conduct the PCR reaction. The temperature record shows the operation temperature conditions for the PCR reaction are 94° C. for 15 seconds, 56° C. for 30 seconds and 72° C. for 30 seconds, and repeat the operation 30 times under these temperature conditions.

When the reaction reagent fluid conducts a PCR reaction in the main channel chamber 31, the main channel chamber 31 reaches the PCR reaction temperature, the inlet sub-channel 32 and outlet sub-channel reach the room temperature. Because the inner diameters of the inlet sub-channel 32 and outlet sub-channel 33 are smaller, the reaction reagent fluid of the inlet sub-channel 32 and outlet sub-channel 33 would become a self-sealing material to seal the opening of the inlet sub-channel 32 and outlet sub-channel 33, and furthermore to prevent the reaction reagent fluid of the main channel chamber 31 from being vaporized so as to facilitate the PCR reaction.

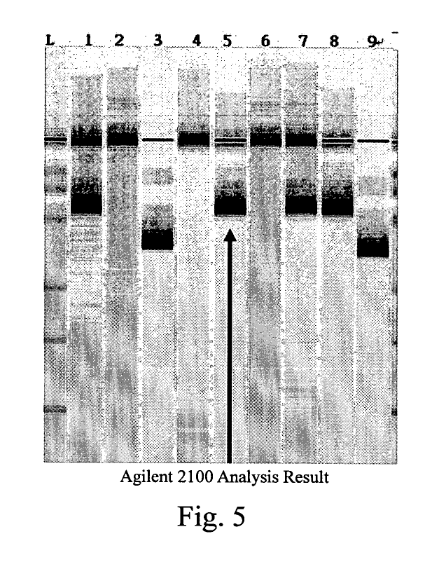

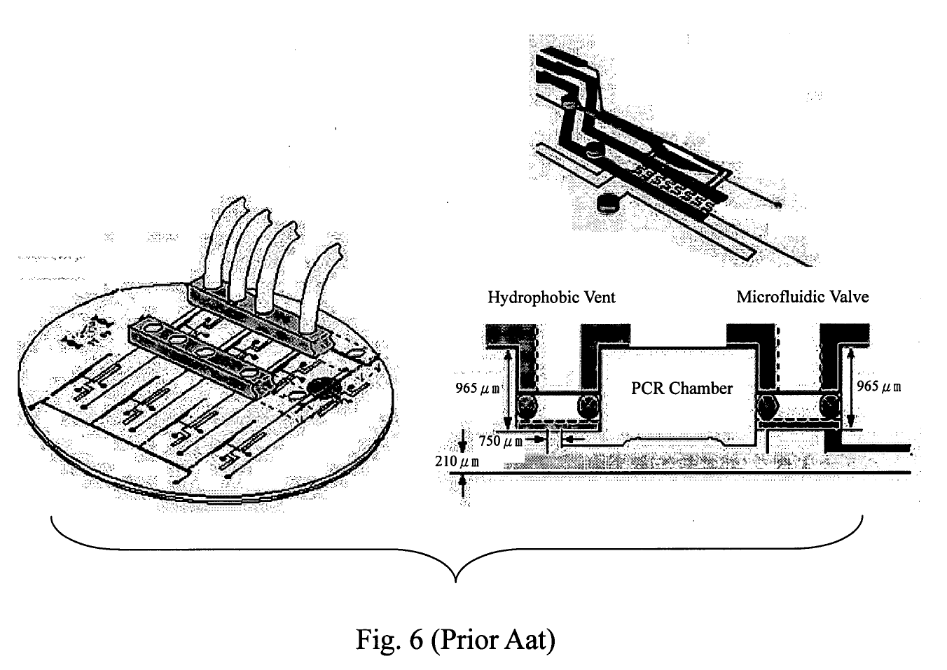

FIG. 5 shows an Agilent 2100 analysis result from DNA amplification of the PCR reaction carried out in the self-sealing high-temperature biochemical reaction apparatus of the present invention, which reveals that the self-sealing high-temperature biochemical reaction apparatus of the present invention can successfully complete the PCR reaction. Furthermore, the reaction time for the present apparatus is less than 1 hour, which is shorter than the reaction time of the conventional chip, and the synthesized quantity of the present apparatus is 1.5 times that of the conventional chip.

When the present apparatus is carrying out a biochemical reaction, the pressure of the main channel chamber 31 is equal to atmosphere pressure. And the reaction reagent of the inlet sub-channel 32 and outlet sub-channel 33 almost does not interchange to each other or flow. As such, the composition of the reaction reagent of the main channel chamber 31 will not vary greatly to influence the result of the biochemical reaction. The present invention provides a simple apparatus and operating method to resolve the problem of the reaction reagent vaporization during the high temperature biochemical reaction. The present apparatus neither requires any clipping device to latch the reaction chamber nor needs additional kind of fluid to prevent the reaction reagent from contacting with atmosphere. The present apparatus has lower manufacturing cost, and is suitable for mass production.

While the invention has been described by way of examples and in terms of preferred embodiments, it is to be understood that those who are familiar with the subject art can carry out various modifications and similar arrangements and procedures described in the present invention and also achieve the effectiveness of the present invention. Hence,. it is to be understood that the description of the present invention should be accorded with the broadest interpretation to those who are familiar with the subject art, and the invention is not limited thereto.

What is claimed is:

1. A self-sealing high-temperature biochemical reaction apparatus, comprising:
a microfluidic channel having a main channel chamber, an inlet sub-channel and an outlet sub-channel, wherein said main channel chamber has an inlet and an outlet respectively communicated with said inlet sub-channel and outlet sub-channel, and inner diameters of said inlet sub-channel and outlet sub-channel are smaller than that of said main channel chamber so that during a biochemical reaction of a reaction reagent filled in said microfluidic channel, said reaction reagent itself seals said inlet sub-channel and outlet sub-channel.

2. The self-sealing high-temperature biochemical reaction apparatus as claimed in claim 1, wherein said main channel chamber is a single chamber or a multi-bending channel.

3. The self-sealing high-temperature biochemical reaction apparatus as claimed in claim 1, wherein further comprises a heater disposed over or under said main channel chamber to control a temperature of said main channel chamber.

4. The self-sealing high-temperature biochemical reaction apparatus as claimed in claim 3, wherein further comprises a temperature sensor associated with said heater to detect the temperature of said main channel chamber.

5. The self-sealing high-temperature biochemical reaction apparatus as claimed in claim 1, wherein said inlet sub-channel and outlet sub-channel are straight-line channels or bending channels.

6. The self-sealing high-temperature biochemical reaction apparatus as claimed in claim 2, wherein said inlet sub-channel and outlet sub-channel are straight-line channels or bending channels.

7. A self-sealing high-temperature biochemical reaction apparatus, comprising:
a first substrate having a first surface formed with a microfluidic channel area, said microfluific channel area including a main channel chamber, an inlet sub-channel and an outlet sub-channel, wherein said main channel chamber has an inlet and an outlet respectively communicated with said inlet sub-channel and outlet sub-channel, and inner diameters of said inlet sub-channel and outlet sub-channel are smaller than that of said main channel chamber;
a heater disposed over a second surface of said first substrate corresponding to said main channel chamber; and
a second substrate disposed over said first surface of said first substrate such that said microfluidic channel area becomes a closed channel area, and said second substrate has an inlet and an outlet respectively communicated with said inlet sub-channel and outlet sub-channel;
wherein during a biochemical reaction of a reaction reagent filled in said micofluidic channel area, said reaction reagent itself seal said inlet sub-channel and outlet sub-channel.

8. The self-sealing high-temperature biochemical reaction apparatus as claimed in claim 7, wherein further comprises a temperature sensor associated with said heater to detect a temperature of said main channel chamber.

9. The self-sealing high-temperature biochemical reaction apparatus as claimed in claim 7, wherein said main channel chamber is a single chamber or a multi-bending channel.

10. The self-sealing high-temperature biochemical reaction apparatus as claimed in claim 7, wherein said inlet sub-channel and outlet sub-channel are straight-line channels or bending channels.

11. The self-sealing high-temperature biochemical reaction apparatus as claimed in claim 9, wherein said inlet sub-channel and outlet sub-channel are straight-line channels or bending channels.

12. A self-sealing method for a high-temperature biochemical reaction, comprising:
providing a microfluidic chip having a main channel chamber, an inlet sub-channel and an outlet sub-channel, said microfluific channel area having a main channel chamber, an inlet sub-channel and an outlet sub-channel, wherein said main channel chamber has an inlet and an outlet respectively communicated with said inlet sub-channel and outlet sub-channel, and inner diameters of said inlet sub-channel and outlet sub-channel are smaller than that of said main channel chamber;
introducing reaction reagent fluid into said inlet sub-channel, main channel chamber and said outlet sub-channel;
detecting a temperature of said main channel chamber and accordingly generating a feedback signal; and
outputting a control signal depending on the feedback signal to control said main channel chamber to reach a reaction temperature such that the reaction reagent fluid itself seals said inlet sub-channel and outlet sub-channel.

13. The self-sealing method for a high-temperature biochemical reaction as claimed in claim 12, wherein said main channel chamber is a single chamber or a multi-bending channel.

14. The self-sealing method for a high-temperature biochemical reaction as claimed in claim 12, wherein said inlet sub-channel and outlet sub-channel are straight-line channels or bending channels.

15. The self-sealing method for a high-temperature biochemical reaction as claimed in claim 13, wherein said inlet sub-channel and outlet sub-channel are straight-line channels or bending channels.
